(19) United States
(12) Patent Application Publication
(10) Pub. No.: US 2012/0303395 A1
(43) Pub. Date: Nov. 29, 2012

(54) Relationship Assessment

(75) Inventors: Ankit Saxena, Hyderabad (IN); Viral Chhaya, Hyderabad (IN); Amit Chandra, Gurgaon (IN)

(73) Assignee: BANK OF AMERICA CORPORATION, Charlotte, NC (US)

(21) Appl. No.: 13/113,154

(22) Filed: May 23, 2011

(51) Int. Cl. G06Q 10/00

(52) U.S. Cl. 705/7.11

(57) ABSTRACT

Systems and methods of evaluating and/or assessing the health of a relationship are provided. In some examples, the systems and methods may include identifying a first party and a second party in a relationship. The systems and methods may further include determining a plurality of parameters for evaluation. In some examples, a first portion of the parameters may be evaluated based on what the second party thinks of the first party from a business engagement perspective. Another portion of the parameters may be evaluated based on how well prepared the first party is to meet the business needs of the second party. The scores may be combined to determine an overall health of the relationship and, in some examples, the results may be represented graphically and/or using color to indicate the health of the relationship.

### BACKGROUND

Relationships in business are necessary to succeed. Various relationships exist in any business, including those between partners, members of a team, vendor and customer, etc. In order to succeed in business, it is important to foster these relationships and ensure that they are strong and healthy. However, determining the health of a relationship can be difficult. Often, evaluations of a relationship are subjective which makes comparison between evaluations difficult or impossible. Accordingly, a system and method of evaluating business relationships, both based on the performance of one party and that party's performance against the expectations of the other party, would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, systems and methods of evaluating and/or assessing the health of a relationship are provided. In some examples, the systems and methods may include identifying a first party and a second party in a relationship. The systems and methods may further include determining a plurality of parameters for evaluation. In some examples, a first portion of the parameters may be evaluated based on what the second party thinks of the first party from a business engagement perspective. Another portion of the parameters may be evaluated based on how well prepared the first party is to meet the business needs of the second party. The scores may be combined to determine an overall health of the relationship and, in some examples, the results may be represented graphically and/or using color to indicate the health of the relationship.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be implemented.

FIG. 2 illustrates an example system for assessing the health of one or more relationships according to one or more aspects described herein.

FIG. 3 illustrates one example method of assessing the health of a relationship according to one or more aspects described herein.

FIG. 4 illustrates one example scoring matrix for determining an overall health of a relationship according to one or more aspects described herein.

FIG. 5 illustrates one example scale used to illustrate scores used in determining the health of a relationship according to one or more aspects described herein.

FIG. 6 illustrates one example graphical depiction of the results of the assessment of the health of a relationship according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

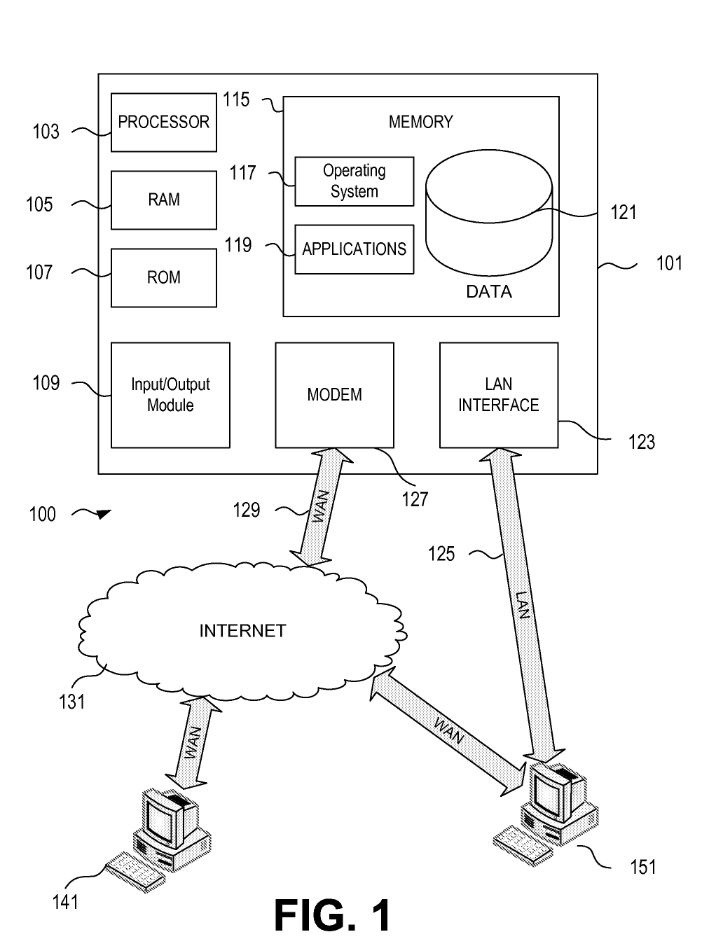

FIG. 1 illustrates a block diagram of a generic computing device 101 (e.g., a computer server) in computing environment 100 that may be used according to an illustrative embodiment of the disclosure. The computing device 101 may have a processor 103 for controlling overall operation of the device and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The computing device 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the server 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions or other entities, to evaluate the health of one or more business relationships. Some example relationships may include those between a service provider and a principle, between partners within a line of business, between a vendor and a customer, and between members of a team. The systems and methods described herein may be used to evaluate the health of various other relationships without departing from the invention.

The systems and methods herein may be used to evaluate the health of a relationship. In some examples, the systems and methods may include a plurality of parameters for evaluation. A score may be determined for each of the parameters of the plurality of parameters and the scores may be combined to determine an overall score indicating the health of the relationship. In some examples, a portion of the parameters may be evaluated from a perspective of a first party of the relationship, while another portion of the parameters may be evaluated from a perspective of a second party in the relationship. For instance, in the vendor and customer relationship, a first portion of the parameters may be directed outward to evaluate the performance of the vendor on the expectations or in the perceptions of the customer, while a second portion of the parameters may be directed inward, toward the vendor's self-evaluation of its own capability and readiness to meet the customer's expectations.

In some arrangements, the scores of each parameter and/or the results or overall health of the relationship, may be displayed graphically. For instance, the scores may be displayed on a sliding scale (e.g., −5 to +5, 1 to 10, etc.). In some examples, the scale may include color to aid in distinguishing between positive results and negative results. For instance, the scale may progress from dark blue through lighter shades of blue to light shades of red and onto darker shades of red, indicating warm or hot (red) and cool or cold (blue). Relationships having good health may be in the warm or hot (e.g., red) zone while relationships having poor health may be in the cool or cold (e.g., blue zone). Various other color or graphical representations of the scores may be used without departing from the invention.

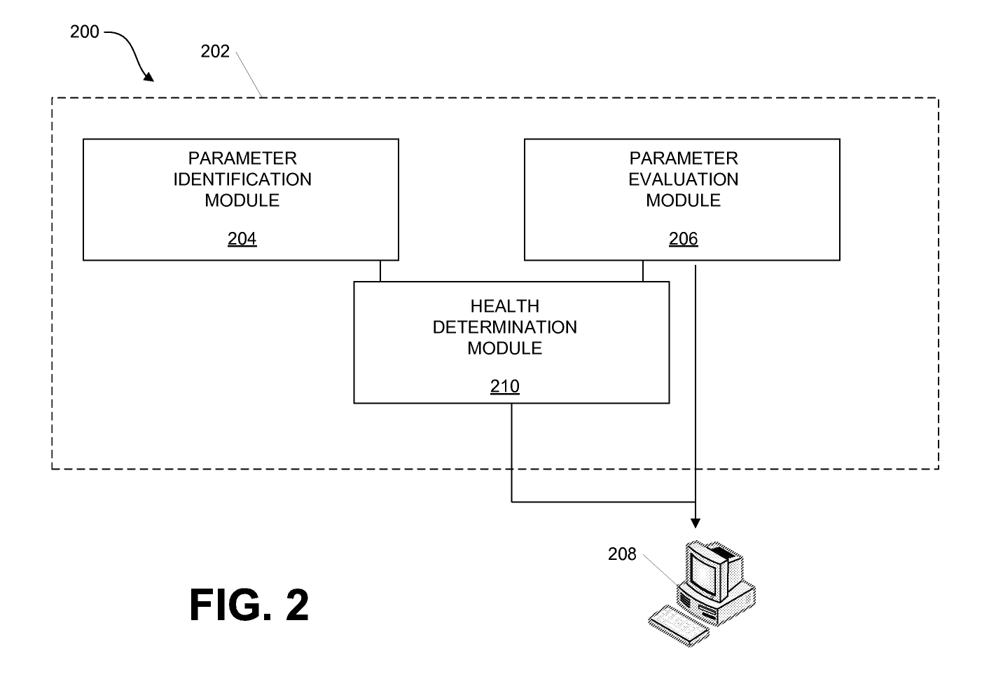

FIG. 2 illustrates one example relationship assessment system 200 according to at least some aspects described herein. The relationship assessment system may be part of or associated with an entity 202, such as the entity implementing the system. The entity may be a business, corporation, university or other educational institution, government agency, and the like. In some examples, the entity may be a financial institution, such as a bank. The relationship assessment system 200 may include a parameter identification module or engine 204. The parameter identification module 204 may identify one or more parameters for evaluation. For instance, as discussed above, the parameter identification module 204 may identify a plurality of parameters. A portion of the parameters identified may be outward parameters that may include how a second party in a relationship thinks about a first party in the relationship from a business engagement perspective. In some examples, the outward parameters may include one or more of: engagement quality, visibility, seat on table, stakeholder (e.g., party) analysis, value creating partner, and the like. Although five outward parameters are provided, more or fewer parameters may be used without departing from the invention. Further, other parameters not listed above may be used with the relationship assessment system and method described herein without departing from the invention.

Another portion of the parameters identified by the parameter identification module 204 may include inward parameters. For instance, inward parameters may be an evaluation or indication of how well the first party in the relationship is prepared for the second party's business needs. In some examples, inward parameters may include one or more of: knowledge of the business of the second party or of the line of business, domain capability, stakeholder or party dependency, stakeholder or party need awareness, and solution awareness. Although five inward parameters are provided, more or fewer parameters may be used without departing from the invention. Further, other parameters not listed above may be used with the relationship assessment system and method described herein without departing from the invention.

The relationship assessment system 200 may also include a parameter evaluation engine or module 206. The parameter evaluation module 206 may evaluate the parameters identified by the parameter identification module 204 in view of the relationship being assessed and the parties of the relationship. In some examples, user input may be received by the parameter evaluation module 206 to determine a score for the identified parameters. For instance, a user may access the parameter evaluation module 206 through a user computing device, such as computer 208. Computer 208 may include various types of computing devices, such as laptop computers, desktop computers, smart phones, cell phones, personal digital assistants, and the like.

In some arrangements, the user may input a score for each identified parameter. The score may be determined based on a predefined scale. For instance, some relationship assessment systems and methods may be scored on a scale of −5 to +5. In other arrangements, the score may be on a scale of 1 to 10, 0 to 10, 1 to 100, etc. Various other scales may be used without departing from the invention.

The value of the score may be based on predefined thresholds for each scoring value. The scoring examples provided below are generally based on a scale of −5 to +5. However, as discussed above, various other scales may be used without departing from the invention.

In one scoring example, the outward parameter engagement quality may represent the qualitative aspect of the first party's relationship with the second party. A score of +5 to +2 may be considered a “high” rating that may indicate a very strong business bond with the second party in the relationship and/or may indicate a great engagement. A score of +1 to −1 may be considered a “medium” rating that may indicate the relationship between the first party and the second party is a casual relationship, neither too high nor too low. A score of −2 to −5 may be considered a “low” rating that may indicate a mild or non-existent engagement with the second party in the relationship.

In another scoring example, the outward parameter visibility may represent how and/or whether the first party is involved with or a part of the business plan preparations by the second party. A score of +5 to +2 may be considered a “high” rating and may indicate that the first party is equally involved in business related decisions and planning with the second party. A score of +1 to −1 may be considered a “medium” rating and may indicate that, although the first party may know the business plans, they may not be involved in strategic discussions related to the business. A score of −2 to −5 may be considered a “low” rating and may indicate that the first party is not consulted or involved with the business decisions/planning of the second party.

In yet another example, the outward parameter seat on the table may represent whether the first party is treated equally as a direct report, colleague, partner, etc. of the second party in the relationship. A score of +5 to +2 may be considered a “high” rating and may indicate that the first party is treated equally. A score of +1 to −1 may be considered a “medium” rating and may indicate that the communication and/or governance mechanisms of the first party are channeled through an intermediary and there may be no direct contact with the leaders of the second party. A score of −2 to −5 may be considered a “low” rating and may indicate that no communication takes place between the first party and the leaders of the second party.

In still another example, the outward parameter stakeholder analysis may represent whether the second party supports the first party and their actions, initiatives, proposals, etc. A score of +5 to +4 may be considered a “promoter” rating and may indicate that the second party is pleased with the first party and supports the first party in all initiatives, actions, proposals, etc. related to business needs. In this scoring threshold, the second party may be a champion of the first party and may endorse the first party. A score of +3 to +2 may be considered a “neutral” rating and may indicate the second party is satisfied with the performance of the first party and/or the initiatives, proposals, etc. of the first party. A score of +1 to −5 may be considered a “detractor” rating and may indicate that the second party is unhappy and may lead to damage to the relationship.

In yet another example, the outward parameter value creating partner may represent whether the first party believes that the second party feels that the first party creates value for the business of the second party. A score of +5 to +2 may be considered a “high” rating and may indicate that the second party's perception of the first party, in terms of creating value for the business is positive and/or strong. A score of +1 to −1 may be considered a medium rating and may indicate that the second party is not sure whether the first party creates value for the business. A score of −2 to −5 may be considered a “low” rating and may indicate that the second party does not think that the first party creates value for the business.

Example inward scoring thresholds and parameters are provided below. For simplicity, the −5 to +5 scale will again be used in these examples. However, other scales may be used without departing from the invention.

In one scoring example, the inward parameter line of business knowledge may represent the first party's knowledge of the second party, their hierarchies, governance structures, process architecture, etc. This may indicate organizational awareness on the part of the first party. A score of +5 to +2 may be considered a “high” rating and may indicate that the first party has a thorough knowledge of the second party and the aspects of the second party discussed above. A score of +1 to −1 may be considered a “medium” rating and may indicate that the first party has a limited understanding of the identified aspects of the second party. A score of −2 to −5 may be considered a “low” rating and may indicate the first party has no understanding of the above-described aspects of the second party.

In another example the inward parameter domain capability may represent the first party's preparedness in terms of understanding and experience in a domain and the ability to service it. A score of +5 to +2 may be considered a “high” rating and may indicate the first party has a high understanding and experience of a particular domain and that the first party has a number of appropriately skilled and qualified people working with them. A score of +1 to −1 may be considered a “medium” rating and may indicate the first party has some understanding and experience but not a satisfactory level. A score of −2 to −5 may be considered a “low” rating and may indicate the first party has little or no understanding and experience of the domain.

In yet another example, the inward parameter party or stakeholder dependency may represent the first party's dependency on the second party in terms of business knowledge, decision making, day to day work, etc. A score of +5 to +2 may be considered a “low” rating and may indicate that the first party is self-sufficient and has minimal dependency on the second party for anything related to business. A score of +1 to −1 may be considered a “medium” rating and may indicate that the first party is neither too high nor too low in terms of dependency. A score of −2 to −5 may be considered a “high” rating and may indicate the first party is highly dependent on the second party for anything related to the business.

In still another example, the inward parameter stakeholder need awareness may represent how aware the first party is of the second party's business needs and requirements. A score of +5 to +2 may be considered a “high” rating and may indicate that the first party is excellent in predicting and identifying the second party's business needs and requirements upfront. A score of +1 to −1 may be considered a “medium” rating and may indicate the first party is reactive to the business needs and requirements (e.g., the first party can not predict but can react when once informed). A score of −2 to −5 may be considered a “low” rating and may indicate the first party can neither predict nor react to the second party's business requirements and needs.

In yet another example, the inward parameter solution awareness may represent the first party's solution providing capability for the second party. A score of +5 to +2 may be considered a “high” rating and may indicate the first party is aware of solutions they can provide to the second party's business challenges and needs. A score of +1 to −1 may be considered a “medium” rating and may indicate the first party has some idea of how they can solve the business challenges and needs of the second party. A score of −2 to −5 may be considered a “low” rating and may indicate the first party has no idea how to solve the business needs and challenges of the second party.

These various scoring thresholds, although merely one example of thresholds and guidelines that may be used in evaluating identified parameters, may aid in providing more objective scoring results by providing criteria for assigning each score in each parameter.

The relationship assessment system may further include a health determination module 210. The health determination module may receive the evaluated parameters (e.g., scores for each parameter) and may combine the scores to determine an overall health of the relationship. For instance, in one example, an average of the outward parameters scores may be determined and an average of the inward parameters scores may be determined. The overall score may be the average of these two scores. In some arrangements the health determination module 210 may assign a weighting value to one or more parameters. This weighting may aid in underscoring one or more parameters that are particularly important.

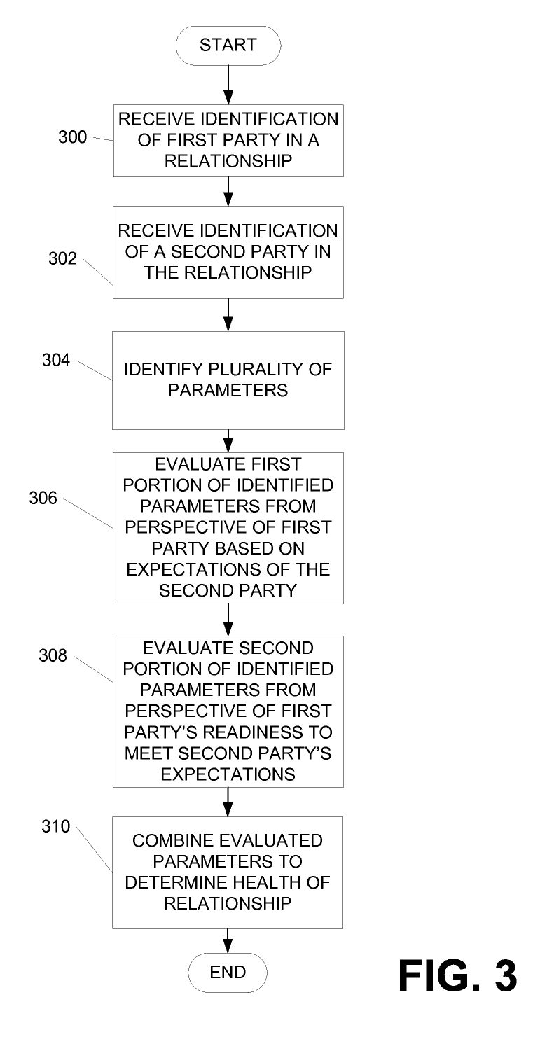

FIG. 3 illustrates one example method of determining the health of a relationship. In step 300, a first party in a relationship is identified. As discussed above, any type of relationship (e.g., business relationship) may be evaluated, including, for example, those between a service provider and a principle, between partners within a line of business, between a vendor and a customer, and between members of a team, and the like. In step 302, a second party in the relationship is identified. In step 304, a plurality of parameters for evaluation is identified. In some arrangements, the parameters may be identified by a parameter identification module, such as module 204 in FIG. 2. In step 306, a first portion of the plurality of identified parameters is evaluated. In some examples, the first portion of parameters may be outward parameters that may be evaluated based on the first party's performance based on the expectations of the second party. In step 308, a second portion of the plurality of identified parameters may be evaluated. In some examples, the second portion of the parameters may be inward parameters that evaluate the first party's readiness to meet the needs of the second party. As discussed above, evaluation of the parameters may include providing a score for each parameter. In step 310, the evaluated parameters are combined to determine an overall health of the relationship. The determined overall health of the relationship may then be used to identify one or more relationships that are in need of resources, attention, etc.

The relationship assessment system and method described herein may be used one time to evaluate a relationship, or may be used on a continuous basis to continuously evaluate one or more relationships to track the relationship, identify any areas in need of improvement, etc. Continuous monitoring of the relationship may also aid in early identification of areas that may have been performing well but are beginning to perform less well.

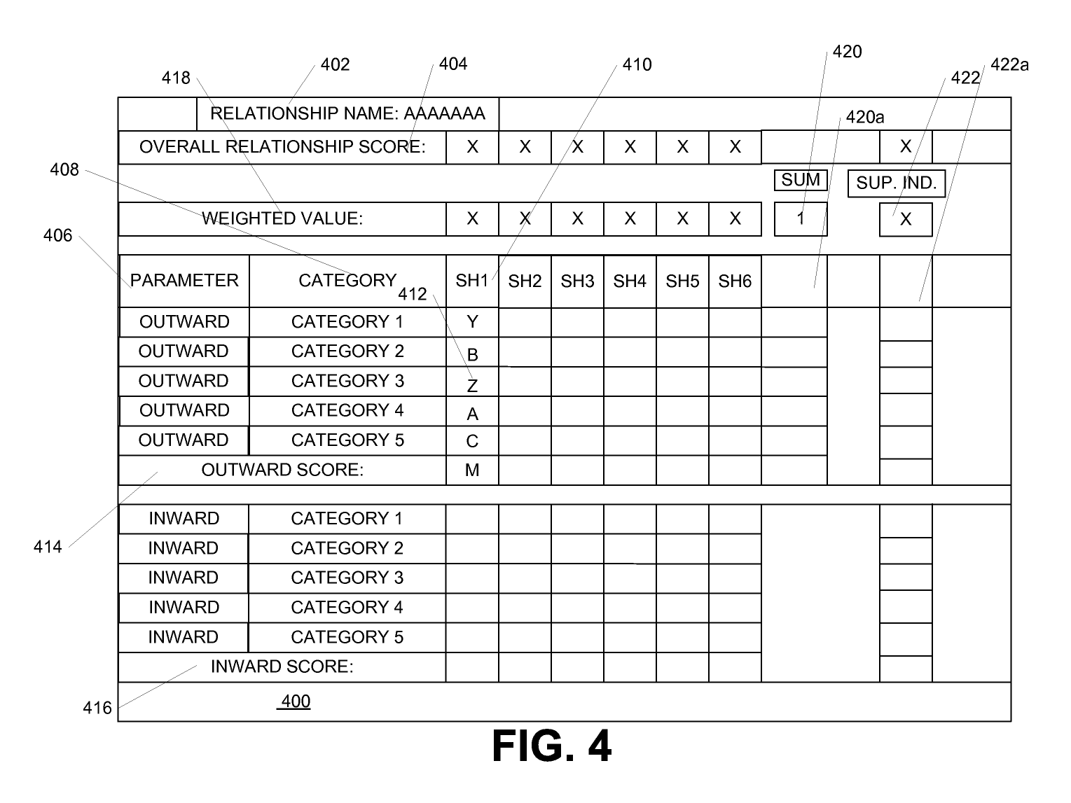

FIG. 4 illustrates one example matrix 400 that may be used for inputting scores for each parameter. In field 402 a name or other identifier of the relationship being evaluated is provided. Field 404 indicates an overall relationship score. In some examples, as discussed above, the overall relationship score may be an average of an outward parameter score and an inward parameter score. Column 406 lists a type of parameter being evaluated (e.g., outward, inward, etc.) while column 408 lists the parameter being evaluated. Some parameters that may be evaluated include, as discussed above, engagement quality, visibility, seat on table, stakeholder analysis, value creating partner, business knowledge, domain capability, stakeholder dependency, stakeholder needs awareness, solution awareness, and the like. Column 410 provides region for scoring each parameter identified in column 408. The score provided (e.g. 412) may be based on a predetermined scale and predetermined criteria for each score, as discussed above. In some examples, more than one individual or stakeholder involved in the relationship may evaluate the parameters. Accordingly, multiple columns SH1-SH6 are provided. More or fewer columns may be provided based on the number of individuals evaluating the parameters.

In some arrangements, the scoring scale for each parameter may also be displayed alongside or with the matrix. Although this arrangement is not shown in FIG. 4, it may be used without departing from the invention.

Field 414 provides an overall outward score for each individual evaluating the parameters and field 416 provides an overall inward score for each individual evaluating the parameters. These scores may be combined (e.g., averaged) to determine the overall health of the relationship. The overall health score may be shown in field 404 corresponding the individual evaluating the parameters. In some examples, a weighted value may be provided for each individual evaluating the parameters. For instance, if an individual is more enmeshed with the relationship, their evaluation of the parameters may be given more weight since they may be more intimately familiar with the relationship. In some examples, the weighting factors given to the individuals may sum to 1, as shown in field 420.

Field 420, and column 420a, may represent combination or rolled up scores. For instance, field 420 may represent the sum of the weighting factors, as discussed above. Further, the scores provided by each individual in the multiple columns SH1-SH6 may be rolled up or combined and represented in column 420a. In some examples, the rolled up score in column 420a may be an average of the scores for each individual SH1-SH6. Further, in some arrangements, the weighting value may be applied to the score of each individual SH1-SH6 and then an average taken. This combined or rolled up score in column 420a may indicate and overall score for the particular parameter for all individuals SH1-SH6 rating that parameter. In some examples, in may indicate an overall score of the performance of that parameter for the group of individuals rating the parameter.

In field 422 and corresponding columns, the supervisor for a party may evaluate the parameters. The supervisor score may be shown separately in field 422 and individual scores for each parameter may be shown in column 422a. In some arrangements, the scores in column 422a may be compared with those in 420a to provide an indication of how a supervisor scores or rates a particular parameter as compared with the individuals within the supervisor's group who may be scoring the parameter. This may aid in identifying issues for a particular parameter, or overall for the relationship, between the supervisor and the group.

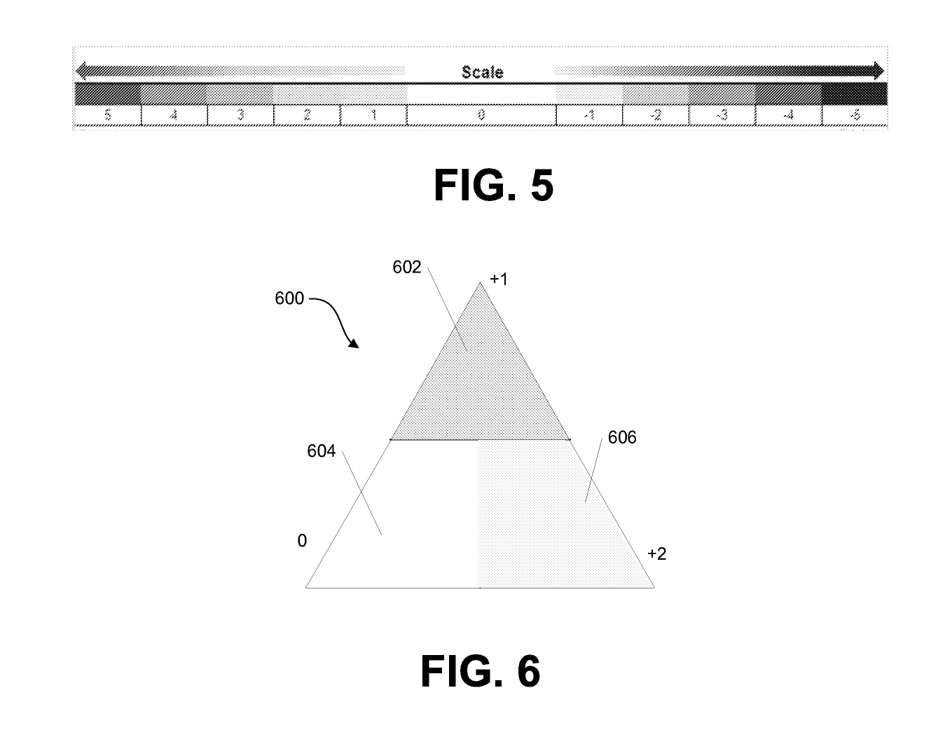

In some examples, color may be used to provide a visual indication of the health of a relationship or of a score provided for a parameter. For instance, a color scale may be used extending from red to blue. The darkest red may indicate the best score while the darkest blue may indicate the worst score. An opposite arrangement in which red indicates a worse score than blue may also be used. Further, various other colors may be used in the scale without departing from the invention. One example color scale is provided in FIG. 5. A scale of −5 to +5 is shown, however other scales may be used without departing from the invention.

As discussed above, a score of +5 corresponds to generally the best score and is thus associated with the darkest red. A score of −5 corresponds generally to the worst score and is thus associated with the darkest blue. The red gradually becomes lighter as the scores get worse. A score of zero may be associated with white. As the scores continue to extend toward −5, the blue may go from light to dark. As discussed above, various other color schemes may be used without departing from the invention.

With further reference to FIG. 4, a score provided in column 410 may be shown in the color corresponding to that score on the scale in FIG. 5. Additionally or alternatively, the background of the score field may be shown in the corresponding color. Accordingly, using the example scale provided, a score in column 410 of +5 may be shown in the darkest red while a score of +2 may be shown in a lighter red. This may aid in providing a quick, visual indication to a user of where the scores fall. One or two blue scores among several red may indicate that the relationship is generally strong but the blue areas are in need of improvement. Those blue areas in need of improvement may be easily identifiable using the color scale provided.

The outward score, inward score and overall relationship score may also be provided in the color corresponding to the score or with a background showing the color corresponding to the score. Again, the color may provide a quick, visual indication of the health of the relationship.

In some examples, the health of the relationship may be illustrated graphically. For instance, FIG. 6 illustrates one example graphical representation 600 of the results of the health assessment. Region 602 may correspond to the overall health of the relationship. Region 602 may include the score determined for the overall health and may also be illustrated in the color corresponding to the score for the overall health. Regions 604 and 606 may correspond to the outward score and inward score, respectively. The position of the regions may change without departing from the invention. Regions 604 and 606 may also include the score for those parameters and may be shown in the color associated with the determined score. Grayscale is used to illustrate that color may be provided in the regions 602, 604, 606 to indicate the score.

As discussed above, the relationship assessment system and method described herein may be used to evaluate and/or monitor one or more relationships. The tool may be used one time to gain an understanding of a relationship or continuously to monitor the relationship over time. The system and method may be used to identify relationships and/or areas within a relationship needing improvement, as well as areas that are strengths which may be maintained. Further, the use of color may provide a quick, visual indication of the health of the relationship.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

1. An apparatus, comprising:
at least one processor; and
memory operatively coupled to the processor and storing computer readable instructions that, when executed, cause the apparatus to:
identify a first party in a relationship;
identify a second party in the relationship;
identify a first plurality of parameters for evaluation of the relationship from a perspective of the first party, wherein the first plurality of parameters for evaluation of the relationship correspond to how the first party thinks about the second party from a business engagement perspective;
identify a second plurality of parameters for evaluation of the relationship from a perspective of the second party, wherein the second plurality of parameters for evaluation of the relationship correspond to how well the second party is prepared to meet the business needs of the first party;
evaluate the first plurality of parameters and the second plurality of parameters; and
combine the evaluated first plurality of parameters and the evaluated second plurality of parameters to determine an overall health of the relationship.

2. The apparatus of claim 1, wherein evaluating the first plurality of parameters includes determining a score associated with each of the parameters of the first plurality of parameters.

3. The apparatus of claim 2, wherein evaluating the second plurality of parameters includes determining a score associated with each of the parameters of the second plurality of parameters.

4. The apparatus of claim 3, wherein determining the overall health of the relationship includes determining an overall score from the determined scores of the first plurality of parameters and the second plurality of parameters.

5. The apparatus of claim 1, wherein the first plurality of parameters includes at least one of: engagement quality, visibility, seat on table, stakeholder analysis, and value creating partner.

6. The apparatus of claim 1, wherein the second plurality of parameters includes at least one of: business knowledge, domain capability, stakeholder dependency, stakeholder need awareness, and solution awareness.

7. The apparatus of claim 1, wherein the overall health of the relationship is displayed graphically with color to indicate a relationship having good health and a relationship having poor health.

8. The apparatus of claim 1, further including identifying a relationship having poor health based on the identified health of the relationship.

9. A method, comprising:
identifying, by a relationship assessment system having at least one processor, a first party in a relationship;
identifying, by the relationship assessment system, a second party in the relationship;
identifying, by the relationship assessment system, a first plurality of parameters for evaluation of the relationship from a perspective of the first party, wherein the first plurality of parameters for evaluation of the relationship correspond to how the first party thinks about the second party from a business engagement perspective;
identifying, by the relationship assessment system, a second plurality of parameters for evaluation of the relationship from a perspective of the second party, wherein the second plurality of parameters for evaluation of the relationship correspond to how well the second party is prepared to meet the business needs of the first party;
evaluating the first plurality of parameters and the second plurality of parameters; and
combining the evaluated first plurality of parameters and the evaluated second plurality of parameters to determine an overall health of the relationship.

10. The method of claim 9, wherein evaluating the first plurality of parameters includes determining a score associated with each of the parameters of the first plurality of parameters.

11. The method of claim 10, wherein evaluating the second plurality of parameters includes determining a score associated with each of the parameters of the second plurality of parameters.

12. The method of claim 11, wherein determining the overall health of the relationship includes determining an overall score from the determined scores of the first plurality of parameters and the second plurality of parameters.

13. The method of claim 9, wherein the first plurality of parameters includes at least one of: engagement quality, visibility, seat on table, stakeholder analysis, and value creating partner.

14. The method of claim 9, wherein the second plurality of parameters includes at least one of: business knowledge, domain capability, stakeholder dependency, stakeholder need awareness, and solution awareness.

15. The method of claim 9, wherein the overall health of the relationship is displayed graphically with color to indicate a relationship having good health and a relationship having poor health.

16. The method of claim 9, further including identifying a relationship having poor health based on the identified health of the relationship.

17. One or more non-transitory computer readable media storing computer readable instructions that, when executed, cause a relationship assessment system of a financial institution to:
identify a first party in a relationship;
identify a second party in the relationship;
identify a first plurality of parameters for evaluation of the relationship from a perspective of the first party, wherein the first plurality of parameters for evaluation of the relationship correspond to how the first party thinks about the second party from a business engagement perspective;
identify a second plurality of parameters for evaluation of the relationship from a perspective of the second party, wherein the second plurality of parameters for evaluation of the relationship correspond to how well the second party is prepared to meet the business needs of the first arty;
evaluate the first plurality of parameters and the second plurality of parameters; and
combine the evaluated first plurality of parameters and the evaluated second plurality of parameters to determine an overall health of the relationship.

18. The one or more non-transitory computer readable media of claim 17, wherein evaluating the first plurality of parameters includes determining a score associated with each of the parameters of the first plurality of parameters.

19. The one or more non-transitory computer readable media of claim 18, wherein evaluating the second plurality of parameters includes determining a score associated with each of the parameters of the second plurality of parameters.

20. The one or more non-transitory computer readable media of claim 19, wherein determining the overall health of the relationship includes determining an overall score from the determined scores of the first plurality of parameters and the second plurality of parameters.

21. The one or more non-transitory computer readable media of claim 17, wherein the first plurality of parameters includes at least one of: engagement quality, visibility, seat on table, stakeholder analysis, and value creating partner.

22. The one or more non-transitory computer readable media of claim 17, wherein the second plurality of parameters includes at least one of: business knowledge, domain capability, stakeholder dependency, stakeholder need awareness, and solution awareness.

23. The one or more non-transitory computer readable media of claim 17, wherein the overall health of the relationship is displayed graphically with color to indicate a relationship having good health and a relationship having poor health.

24. The one or more non-transitory computer readable media of claim 17, wherein the computer readable instructions, when executed, cause the relationship assessment system of the financial institution to identify a relationship having poor health based on the identified health of the relationship.
